(19) United States
(12) Patent Application Publication
(10) Pub. No.: US 2011/0085200 A1
(43) Pub. Date: Apr. 14, 2011

(54) IMAGE FORMING APPARATUS AND NETWORK SYSTEM (MFP OCCUPIED STATUS)

(75) Inventor: Kaori Marunouchi, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/883,634

(22) Filed: Sep. 16, 2010

Related U.S. Application Data
(60) Provisional application No. 61/251,043, filed on Oct. 13, 2009.

(51) Int. Cl. G06F 3/12

(52) U.S. Cl. 358/1.15

(57) ABSTRACT

According to one embodiment, an image forming apparatus including, a storing section configured to store operation states, a communicating section configured to receive an operation instruction and list the operation states to be viewable from an outside, and an image forming section configured to execute instructed processing according to an instruction.

### CROSS-REFERENCE TO RELATED APPLICATIONS

This application is based upon and claims the benefit of priority from: U.S. Provisional Application No. 61/251,043 filed on Oct. 13, 2009, the entire contents of each of which are incorporated herein by reference.

### FIELD

Embodiments described herein relate generally to an image forming apparatus and a network system.

### BACKGROUND

A user can instruct, from an arbitrary PC (Personal Computer) located on a network, an arbitrary MFP (an image forming apparatus called Multi-Functional Peripheral) to perform output (printout) of an image. The user can also extract, in an arbitrary PC on the network, image data read (scanned) by the MFP and apply necessary processing to the image data.

### BRIEF DESCRIPTION OF THE DRAWINGS

A general architecture that implements the various features of the embodiments will now be described with reference to the drawings. The drawings and the associated descriptions are provided to illustrate embodiments and not to limit the scope of the embodiments.

FIG. 1 is an exemplary diagram showing an example of a network system according to an embodiment;

FIG. 2 is an exemplary diagram showing an example of an MFP according to an embodiment;

FIG. 3 is an exemplary diagram showing an example of a list for sharing of the MFP according to an embodiment;

FIG. 4 is an exemplary diagram showing an example of an occupied status of the MFP according to an embodiment; and

FIG. 5 is an exemplary diagram showing an example of a list for predicted idle time according to an embodiment.

### DETAILED DESCRIPTION

In general, according to one embodiment, an image forming apparatus comprising: a storing section configured to store operation states; a communicating section configured to receive an operation instruction and list the operation states to be viewable from an outside; and an image forming section configured to execute instructed processing according to an instruction.

Embodiments will now be described hereinafter in detail with reference to the accompanying drawings.

An example of an embodiment is explained in detail below with reference to the accompanying drawings.

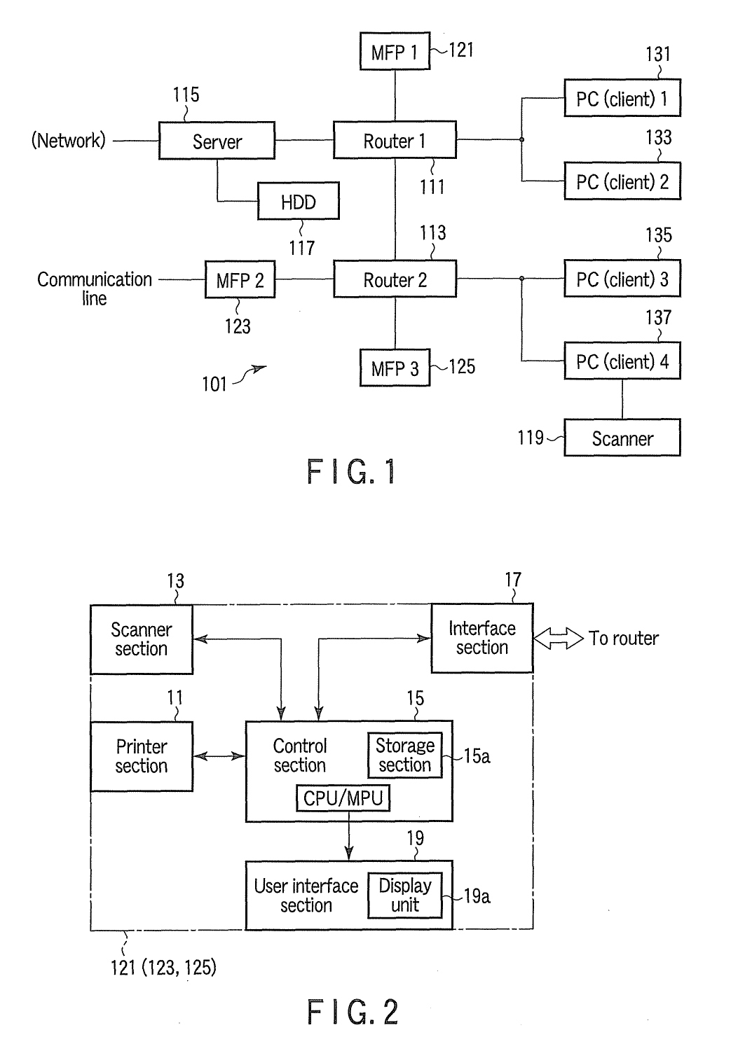

A network 101 shown in FIG. 1 includes plural, for example, two routers 111 and 113 and at least one server 115. The server 115 is desirably connected to an HDD (Hard Disk Drive) 117.

At least one of MFPs (Multi-Functional Peripherals, electronic apparatuses) 121, 123, and 125 and at least one of PCs (e.g., personal computers) 131, 133, 135, and 137 are connected to each of the routers 111 and 113.

At least one of the MFPs 121, 123, and 125 desirably preferentially performs output of image information transmitted from the outside through a communication line.

A scanner 119 configured to capture a hardcopy or an image output (a printout) as image information may be connected to arbitrary one or all of the PCs. In some case, each of PCs may be called a client.

As indicated by an example shown in FIG. 2, each of the MFPs 121, 123, and 125 includes a printer section (an image forming section) 11, a scanner section (an image input section) 13, a control section (a control unit) 15, an interface section (a communication unit) 17, and a user interface section (a user interactive unit, an operation section) 19. The user interactive unit 19 includes a display unit 19a configured to display input information. The user interactive unit 19 desirably includes a function of an authentication unit for authentication of a user, for example, a face authentication unit configured to recognize a characteristic of a face of the user, a biometrics authentication unit configured to authenticate a biological characteristic of a palm or a finger of the user, or a card reader configured to use identification information incidental to an ID card or the like.

In each of the MFPs 121, 123, and 125, the image forming section 11 includes, for example, an electrophotographic system, a thermal transfer system, an ink jet system.

The image input section 13 photoelectrically converts, for example, reflected light or transmitted light obtained by illuminating a target image or text and obtains image information.

The control unit 15 includes a CPU (Central

Processing Unit) or an MPU (Main Processing Unit). The control unit 15 controls, according to a control input received from a client or a server through the user interactive unit 19 or the communication unit 17, image output by the image forming section 11 and acquisition of image information by the image input section 13 and, when necessary, supplies the image information to the communication unit 17. The control unit 15 processes control information (setting) and the like for the image forming section 11, the image input section 13, and the communication unit 17.

The control unit 15 controls, according to a control input received from the router or the server through the communication unit 17, image output by the image forming section 11 and acquisition of image information by the image input section 13 and, when necessary, supplies the image information to the communication unit 17.

The control unit 15 includes a storage section (a storing unit) 15a configured to store control (setting) information, image information, a list for sharing, and the like.

The communication unit 17 exchanges control signals, image information, a list for sharing, a list for occupying, and the like with unspecified PCs (clients) through arbitrary routers 111 and 113. The communication unit 17 exchanges control signals, image information, a list for sharing, a list for occupying, and the like with the server 115 through the arbitrary routers 111 and 113.

The user interactive unit 19 includes a function of an authentication unit for authentication of a user, permission of image formation and output (a copy function), permission of extraction of a received facsimile document (image output), permission of conditioned image formation and output (output of a printout subjected to confidentiality processing), permission of editing of a list for occupying (setting of an interrupt job), for example, a face authentication unit configured to recognize a characteristic of a face of the user, a biometrics authentication unit configured to authenticate a biological characteristic of a palm or a finger of the user, or a card reader configured to use identification information incidental to an ID card or the like.

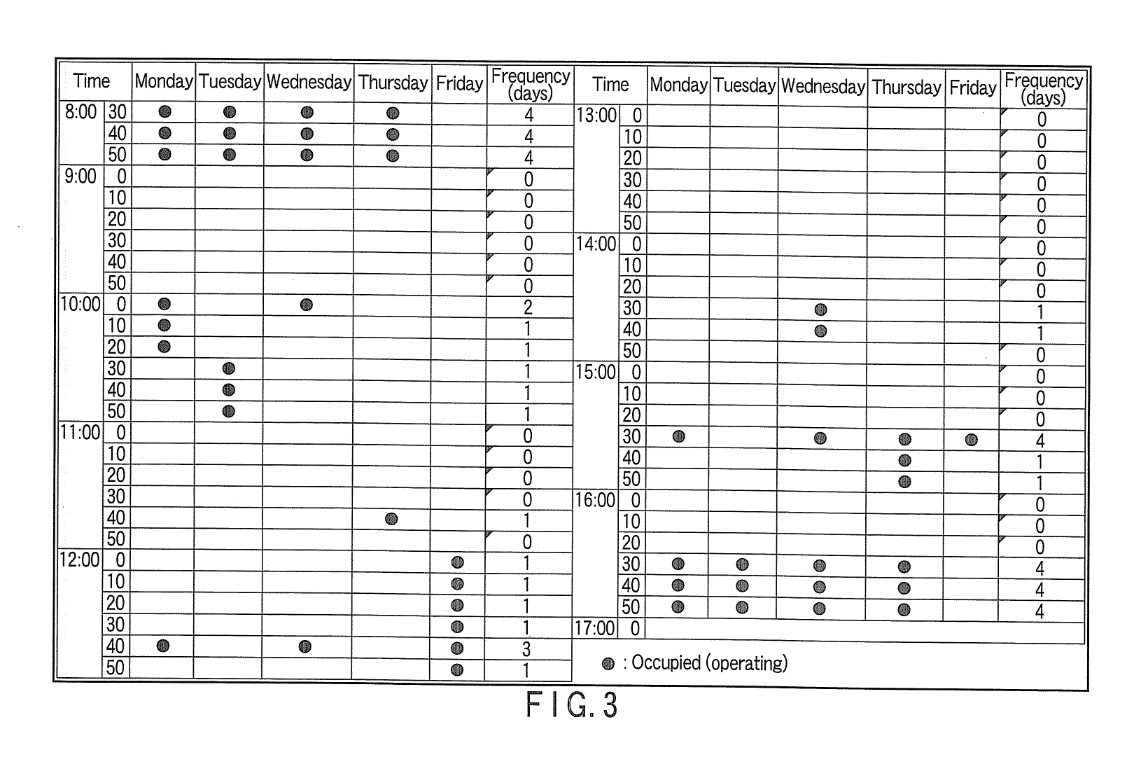

As shown in FIG. 3, an operation state of an arbitrary MFP substantially depends on a day of a week and an hour. In a state in which plural MFPs can be used, in some case, an operating ratio of a specific MFP increases (it is expected that an MFP not having a high operating ratio is present).

Specifically, in an MFP used by plural users, in some case, jobs'overlap and waiting time such as time for waiting turn for image output and time for image reading (use of a scanner of the MFP) often occurs in a setting place of the MFP.

Therefore, it is desirable to record states of use, gather statistics to calculate available functions and hours, and present or notify information concerning the present point and prediction of idle time (when the MFP can be used without waiting time) to clients. Operation states shown in FIG. 3 can be easily extracted from a “log”, a “self-diagnosis record”, and the like peculiar to the MFP. However, the log, the “self-diagnosis record”, and the like may be prepared as a dedicated computer program or application. The “log”, the “self-diagnosis record”, and the dedicated computer program or application may be collectively stored in a server 115 besides being stored in storage of the MFPs.

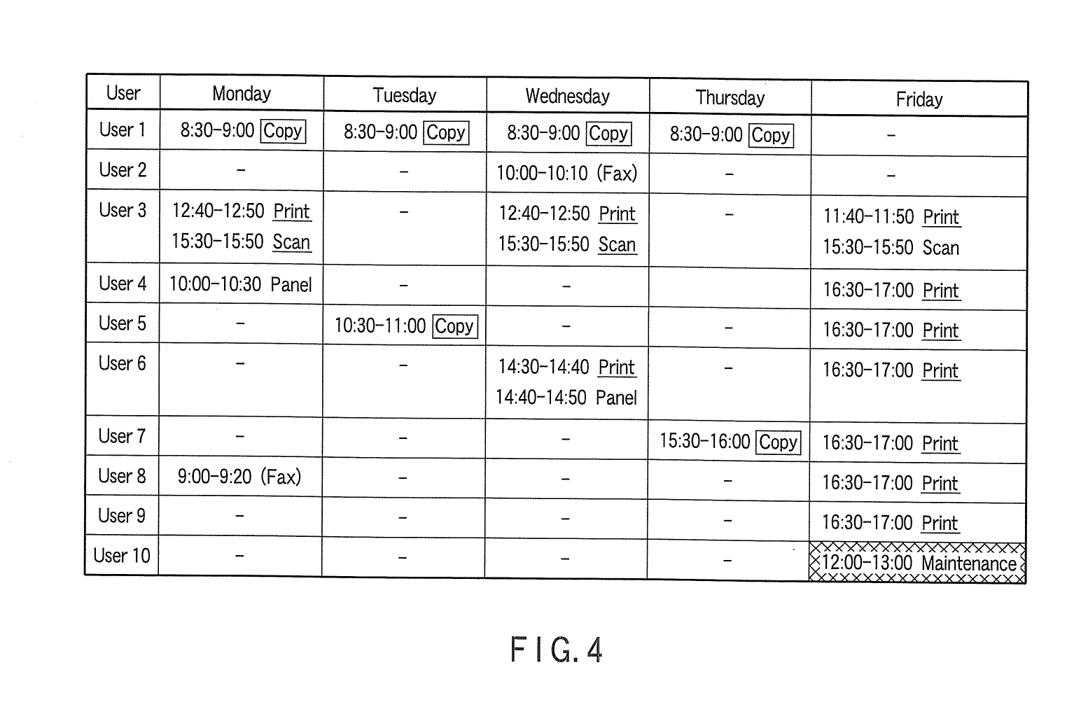

FIG. 4 is a diagram of an example of “idle time prediction” for obtaining, from the operation state of the arbitrary MFP shown in FIG. 3, “idle time information” when the MFP can be used without waiting time.

FIG. 4 indicates that an operating ratio of the

MFP falls for, for example, about 1 hour 30 minutes from 1:00 pm every day. It can be confirmed that the operating ratio of the MFP falls for, for example, about 1 hour from 9:00 am every day.

Therefore, a user who plans to output a large number of images can reduce occurrence of waiting time by executing image output (print out) and copying in a day and time when an operating ratio of the MFP is low. In particular, when there is enough room in time necessary for image output (print out) and copying of a material or the like used in a meeting next week, a reduction in waiting time and improvement of work efficiency can be expected by scheduling the use of the MFP in a day and time when waiting time is short.

Specifically, this is as a result of recording times when arbitrary (general) users, an administrator, and the like (clients) use the MFP and functions (copying, scanning, image output (print out), facsimile transmission, facsimile reception, etc.), obtaining a “frequency of use” according to a statistical method on the basis of a recording result, and calculating the “frequency of use” as “idle time prediction” according to ‘idle time prediction calculation setting’. ‘Idle time information’ conforming to an environment in which a user is located can be obtained by combining a method of recording (operating time and an operating ratio) used in the statistical method and conditions not included in the recording.

For example, as a period in which statistics are gathered,
<1> data for one week is recorded and statistics are issued every week, or
<2> data for one month is recorded and statistics are issued every month.

This makes it possible to suppress statistical data from undesirably occupying a capacity of the HDD 117 connected to the server 115 (adjust the period in which statistics are gathered to the capacity of the HDD). If there is time when the MFP is substantially occupied such as the day before a regular meeting (e.g., once a week) or n hours (n is a natural number) before the meeting, it is possible to suppress an amount of statistical data by, for example, excluding the time. Moreover, it is possible to expect that accuracy of the ‘idle time information’ is improved. In other words, the accuracy of the ‘idle time information’ can be improved by using a frequency of use of the MFP known in advance in a set period for the ‘idle time prediction calculation setting’.

It can be expected that the accuracy of the ‘idle time information’ is improved by using a frequency (occupied or operating) shown in FIG. 3 for the ‘idle time prediction calculation setting’ (the MFP is identified as operating (occupied) when the frequency is equal to or higher than X times).

For example, it can be expected that the accuracy of the ‘idle time information’ is improved by excluding relatively short “idle time” of about 10 minutes from the “idle time prediction”. It goes without saying that, even if the relatively short “idle time” of about 10 minutes is not excluded according to selection by the user, time as short as about 10 minutes can be displayed (presented) as the ‘idle time information’.

When the “idle time prediction” is calculated, the accuracy of the ‘idle time information’ can be further improved by excluding a period of use of a specific user. For example, when date and time of a meeting is not set, if it is evident that a user who is in a position to prepare a material used in the meeting uses the MFP, it can be expected that the accuracy of the “idle time information” is improved by excluding a period (date and time) of the use by the user. It goes without saying that time for maintenance and the like is excluded.

In the “idle time prediction” shown in FIG. 4, more specifically,
<A> from operating hours and functions of in one week of the MFP, idle time is predicted by setting the idle time prediction calculation setting to (statistical period=one week), (frequency of use=2), and (time not included in idle time prediction=10 minutes), and
<B> from time of use and functions of in one week of the MFP, if there are hours when the MFP is used twice (two days) or more in a week such as
   9:00 to 10:00,
   10:00 to 12:40,
   12:50 to 15:30, and
   15:40 to 16:30,
   idle time can be calculated by, for example, excluding the hours from the idle time prediction.

It goes without saying that, following FIG. 3,
<C> time and days of a week when the MFP actually operates may be displayed.

The “idle time prediction”, i.e., the methods <A>, <B>, and <C> can be easily provided (used) when storages of the MFPs store the “idle time prediction” as a dedicated computer program or application. It goes without saying that the server 115 may store the computer program or the application. If the server 115 stores the computer program or the application, idle time is desirably automatically calculated in the server 115 at a predetermined period or timing or at date and time designated by the user. The computer program or the application can also reside in the PCs (the users (the clients)). It goes without saying that the PCs (the users (the clients)) can access and use the computer program or the application stored by the server 115.

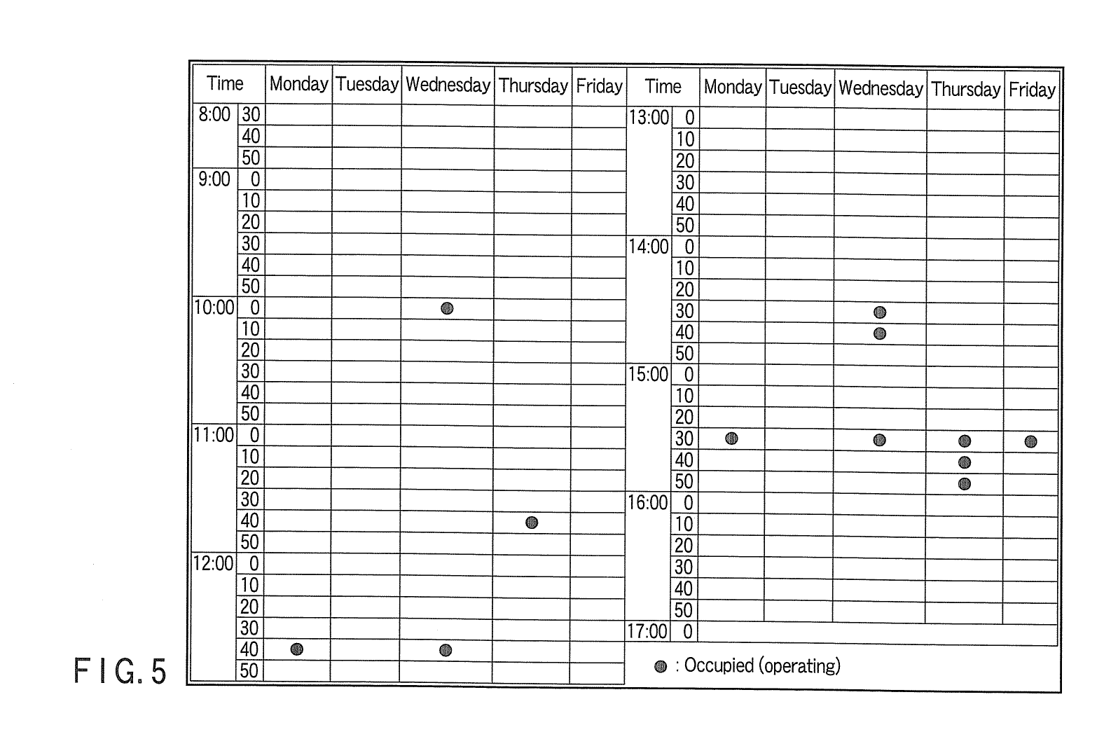

FIG. 5 is a diagram of an example of ‘idle time information’ calculated according to the “idle time prediction” shown in FIG. 4 and presented to the users (the clients). There are arbitrary variations, for example, only time and days of a week when the MFP is available are extracted and displayed.

The ‘idle time information’ shown in FIG. 5 may be stored in, for example, the server 115. However, the ‘idle time information’ may be distributed to the PCs (the users (the clients)) every time the “idle time information” is updated (created) at the timing. If the ‘idle time information’ is distributed to the PCs (the users (the clients)), it is desirable that, for example, a popup function is attached to the ‘idle time information’ and the PCs (the users (the clients)) can always check the ‘idle time information’.

The ‘idle time information’ shown in FIG. 5 may be prepared as, for example, a print (image output) scheduling program (application) for receiving registration of a scheduled job in a wide time frame such as “print between A o'clock and B o'clock”.

If the ‘idle time information’ is prepared as the print (image output) scheduling program (application), it is desirable that the “idle time information” is laid open to the PCs (the users (the clients)) (the PCs (the users (the clients)) share the ‘idle time information’) as a ‘print (image output) scheduling system (scheduler)’ for, for example:
predicting idle time of the MFP with an idle time prediction calculating function to perform printing (image output); and
performing printing in time when the MFP is idle between A o'clock and B o'clock and, if there is no idle time between A o'clock and B o'clock, performing printing in time when it is predicted that a frequency of use is the lowest.

As explained above, according to the embodiment, it is possible to use the MFP with little waiting time according to the ‘idle time information’.

The ‘idle time information’ can be created on the basis of a state of use (operation) of the MFP. Therefore, highly reliable information can be obtained.

If the MFP is occupied and used, the occupied use is excluded from the ‘idle time information’. Therefore, operation efficiency of the MFP is improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a storing section configured to store operation states;
a communicating section configured to receive an operation instruction and list the operation states to be viewable from an outside; and
an image forming section configured to execute instructed processing according to an instruction.

2. The apparatus of claim 1, wherein the communicating section receives a condition for the operation states to be listed.

3. The apparatus of claim 1, further comprising an input section configured to receive a condition for the operation states to be listed.

4. The apparatus of claim 3, wherein the communicating section receives, through the input section, the condition for the operation states to be listed.

5. The apparatus of claim 1, further comprising a non-operation-time calculating section configured to calculate idle time (non-operation time) in the operation states.

6. The apparatus of claim 5, further comprising an input section configured to receive a condition for the operation states to be listed.

7. The printer of claim 6, wherein the communicating section receives, through the input section, the condition for the operation states to be listed.

8. The apparatus of claim 1, wherein the communicating section can access a non-operation-time calculating section included in an external apparatus in order to calculate idle time (non-operation time).

9. A system for image forming comprising:
a first apparatus configured to execute processing instructed by a request, the first apparatus including:
a storing section configured to store operation states;
a communicating section configured to receive an operation instruction; and
an image processing section configured to execute instructed processing according to an instruction;
a second apparatus configured to execute processing instructed by a request, the second apparatus including:
a storing section configured to store operation states;
a communicating section configured to receive an operation instruction; and
an image processing section configured to execute instructed processing according to an instruction; and
a third apparatus configured to acquire the operation states of the first and second apparatuses and list the operation states to be viewable from an outside.

10. The system of claim 9, further comprising a non-operation-time calculating section configured to calculate non-operation time according to the operation states of the first apparatus and the second apparatus.

11. The system of claim 10, wherein the third apparatus includes the non-operation-time calculating section.

12. The system of claim 10, wherein the first apparatus includes the non-operation-time calculating section.

13. The system of claim 10, wherein the second apparatus includes the non-operation-time calculating section.

14. The system of claim 10, wherein each of the first and second apparatuses can access the non-operation-time calculating section, one another.

15. The system of claim 10, further comprising a managing section configured to inform the apparatuses of idle time (non-operation time) calculated by the non-operation-time calculating section.

16. The system of claim 15, wherein the apparatuses can access the managing section.

17. The system of claim 15, further comprising an input section configured to input a condition for the non-operation-time calculating section to calculate the idle time (the non-operation time) to the managing section.

18. The system of claim 17, wherein the input section can input a condition excluded when the non-operation-time calculating section calculates the idle time (the non-operation time).

19. The system of claim 17, wherein the input section can input a condition for excluding time when an image forming apparatus steadily operates from the calculation of the idle time (the non-operation time).

20. A method for image forming comprising:
extracting an operation state contributing to processing instructed by a request; and
calculating a non-operation time.
